(19) United States
(12) Patent Application Publication
(10) Pub. No.: US 2009/0231088 A1
(43) Pub. Date: Sep. 17, 2009

(54) Method for assigning control channels

(75) Inventor: Martin Farnik, Postredni Becva (CZ)

Correspondence Address: HEINZ GRETHER PC;G2 Technology Law, P.O. Box 40610, AUSTIN, TX, 78704, US

(73) Assignee: ROBE SHOW LIGHTING S.R.O.

(21) Appl. No.: 12/075,471

(22) Filed: Mar. 11, 2008

(51) Int. Cl. H04Q 3/00

(52) U.S. Cl. 340/2.2

(57) ABSTRACT

The present invention provides a more efficient use of control signal capacity to control multiparameter automated luminaries by remapping channel assignments within a luminaire. The system taught allows parameter mappings to be group for programming convenience. It allows parameters to be skipped and allows flexibility in the resolution allowable for controlling a parameter. It also allow luminaries to share some channel assignments.

### TECHNICAL FIELD OF THE INVENTION

The present invention generally relates to the control of lighting equipment and specifically to a means for the efficient assignment of control channels to the desired functions. The system disclosed provides improvements to such systems and avoids wasted channels and bandwidth.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will, at the least, provide control over the pan and tilt functions of the luminaire allowing the operator to control the direction the luminaire is pointing and thus the position of the light beam on the stage or in the studio. Products may further provide control over the color, focus, beam size, beam shape and beam pattern or other controllable parameters. The products manufactured by Robe Show Lighting such as the ColorSpot 1200E are typical of the art.

It is very common to control such luminaires to be done through the industry standard protocol, DMX512 which was developed by the United States Institute of Theatre Technology (USITT) in 1986 and has since been adopted and revised by the Entertainment Services Trade Association (ESTA) as an ANSI standard, E1.11. This is an EIA RS-485 based serial protocol designed to transmit 512 bytes of data (or channels) over a pair of data lines from a lighting control desk to a number of luminaires connected in parallel across the data lines. Each luminaire is configured to respond to a pre-defined block of these data bytes or channels and will internally assign them to the parameters needing control. For example channels 1 and 2 may control pan and tilt, 3 may control zoom and so on.

The numbering of channels within the luminaire is relative to a start address or start channel in the 512 byte DMX512 data stream. So, for example, a luminaire may have a DMX512 data block assigned to it which starts at DMX512 byte 76 and contains 10 bytes, finishing with byte 85. The data receiver in the luminaire will pick off bytes 76-85 and assign them internally to channels 1-10 respectively. The internal channels are, in turn, assigned to parameters needing control.

The assignment mapping of DMX512 channels to the internal control channels and hence to physical parameters is typically fixed within the luminaire. A manufacturer may offer more than one such mapping selectable as options but the user cannot freely decide which channels to use, which parameters to use and the mapping between them. Additionally these channels are defined to be consecutive and the user cannot utilize non-consecutive channels.

Additionally the mappings of the values within the channels to particular commands for a parameter are also fixed within the luminaire. A manufacturer may offer more than one such mapping selectable as options but the user cannot freely decide which values will control which command outside of those fixed mapping sets.

More recently it has become possible to transmit DMX512 signals over ethernet network systems rather than over an RS-485 serial data link. Such use allows multiple DMX512 data streams to be sent over a single ethernet cable. Standard industry communication standards such as Artnet and ACN utilize such connections and may be used to transmit DMX512 information from a lighting control console to multiple automated luminaires using an ethernet connection.

U.S. Pat. No. 6,545,586 to Belliveau discloses a means of remotely setting the start address or start channel for such a system but does not disclose means for dynamically altering the mapping.

It would often be advantageous for the user to be able to select the order and mapping of DMX512 control channels to the parameters of a connected automated luminaire or other connected device in order to efficiently lay out the lighting console commands. Such mapping may facilitate the control of such devices and avoid wasted channel space or bandwidth currently consumed with unused parameters.

Consequently there is a need for a system which can provide flexible and efficient assignment of DMX512 control channels to controlled parameters. There is a further need for allowing the mapping of the values within those DMX512 channels to the specific parameter commands.

### DRAWINGS

FIG. 1 is an illustration of an entertainment lighting system.

FIG. 2 is a diagrammatic view of a prior art channel mapping.

FIG. 3 is a diagrammatic view of an embodiment of the channel mapping changes.

FIG. 4 is a diagrammatic view of channel remapping where an available parameter control is bypassed since it is not used.

FIG. 5 is a diagrammatic view of channel remapping where like parameters across fixtures are grouped together.

FIG. 6 is a diagrammatic view of a further embodiment of the present invention showing value mapping.

FIG. 7 shows a diagrammatic view of a further embodiment of the present invention before value mapping.

FIG. 8 shows a diagrammatic view of a further embodiment of the present invention showing value mapping.

FIG. 9 is a diagrammatic view of a yet further embodiment of the present invention showing channel mapping changes.

### DESCRIPTION OF THE PRESENT INVENTION

The present invention generally relates to the control of lighting equipment and specifically to a means for the efficient mapping of control channels to the desired functions. The system disclosed provides improvements to such systems and avoids wasted channels and bandwidth. In a further embodiment the user may assign mapping of channel values to parameter commands.

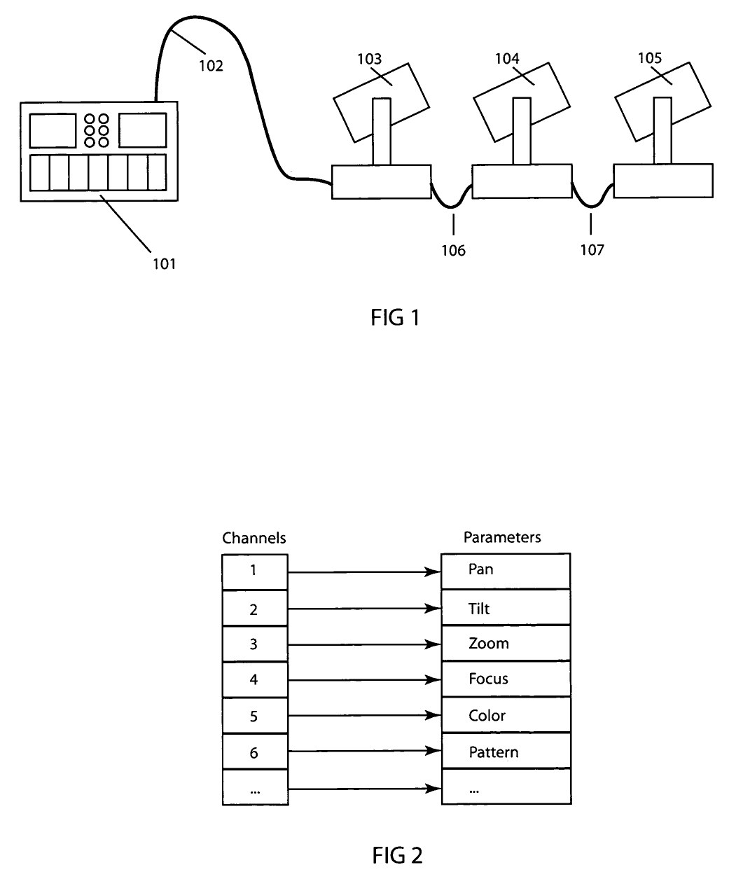

FIG. 1 is an illustration of an example of an entertainment lighting system. Control console 101 is connected to automated luminaire 103 through a control cable 102. Control cable 102 may carry an RS-485 or an ethernet data signal. Automated luminaire 103 is further connected to automated luminaire 104 through control cable 106 and automated luminaire 104 is then connected to automated luminaire 105 through control cable 107. Such serial daisy chain connection of multiple automated luminaires through multiple control cables to form a network is well known in the art.

In a typical system, the communication link established by cables 102, 106 and 107 may be an ethernet connection capable of bi-directional communication between the control console 101 and each of the connected automated luminaires 103, 104 and 105 collectively and separately.

FIG. 2 is a diagrammatic view of a prior art channel mapping. In this mapping the DMX Channels (Only 1-6 of the total possible 512 channels in a DMX universe are illustrated here) are mapped in a one-to-one fixed basis to various parameters within an automated luminaire. Channel 1, for example, is mapped to the Pan parameter of the automated luminaire; channel 2 is mapped to Tilt and so on. An automated luminaire may have more than one of these parameter maps selectable from the luminaire's control panel however the number of such maps offered is limited (typically between 1-3 are offered) and no remapping or adjustment of an existing map is possible.

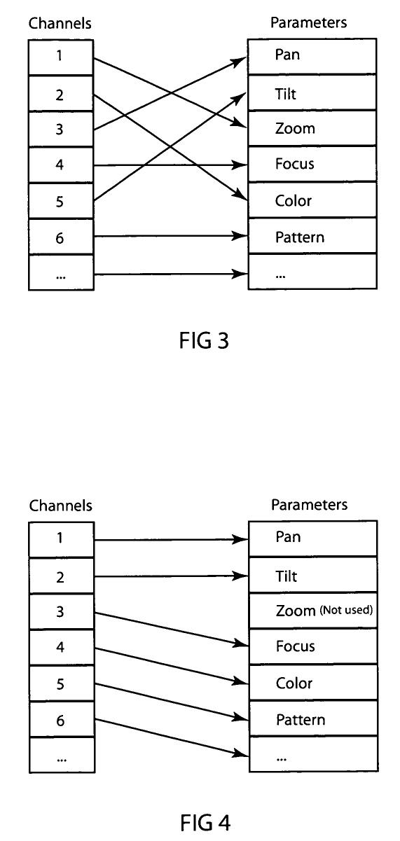

FIGS. 3, 4 and 5 are diagrammatic views of embodiments of the present invention showing channel mapping changes. FIG. 3 illustrates a system where the user has altered the mapping to suit his needs by re-ordering the parameters. In this example the user has re-mapped channel 1 to point to the Zoom parameter, channel 2 to point to the Color parameter and so on.

In one embodiment of the invention the control of such remapping is effected through a web page hosted on and served by the automated luminaire. The user can access the web page embedded on the luminaire either through the control console or by connecting a personal computer with a web browser to the lighting control network illustrated in FIG. 1. The remapping functions on the automated luminaire's web page may then be controlled through drag-and-drop or other control functionality well known in the art.

For example, in a graphical layout such as illustrated in FIG. 3, the user may select Channel 1 with the cursor, click and hold the mouse button, then drag the cursor over to the ‘Zoom’ parameter where the mouse button is released. This assigns Channel 1 to the Zoom function in the current map. Many other web based solutions are possible such as selection from menus, check boxes etc as are well known in the art.

In a further embodiment of the invention the control of such remapping is effected through a control panel or other user control on the automated luminaire. Many automated luminaires have a display and controls to allow a user to make configuration changes to the system. Such a display and control may be used to select and configure control channel remapping. An example of such a control panel is the Robe Navigation System.

In a yet further embodiment of the invention the control of such remapping is effected through a DMX512 link using the RDM (Remote Device Management) protocol or through other network or control mechanism as known in the art.

Once a new channel mapping is established for that automated luminaire from any of the luminaire control panels, control console, RDM, connected personal computer or other connected control device the automated luminaire will retain and utilize that mapping until commanded otherwise and the personal computer may be removed from the lighting control network.

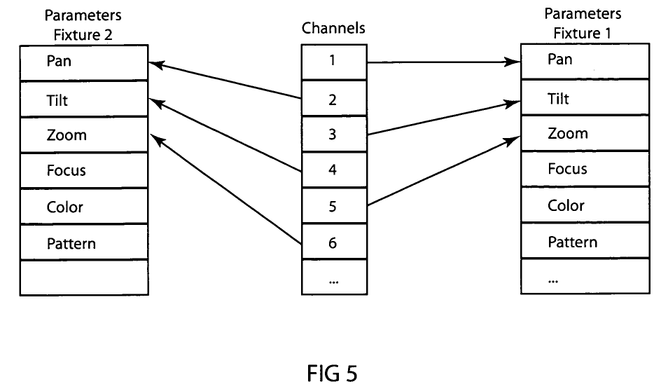

FIG. 4 illustrates a different utilization of channel mapping where the user has determined that he has no need for the Zoom parameter in the present show or event. A new mapping is established through the same means as described above which removes any mapping to the Zoom parameter. The illustrated mapping frees the DMX512 channel previously assigned to Zoom to be used for a different parameter. Such removal of unused parameters may release sufficient capacity on the DMX512 link to allow further automated luminaires to be connected to the network without having to establish an additional network with its own cabling system.

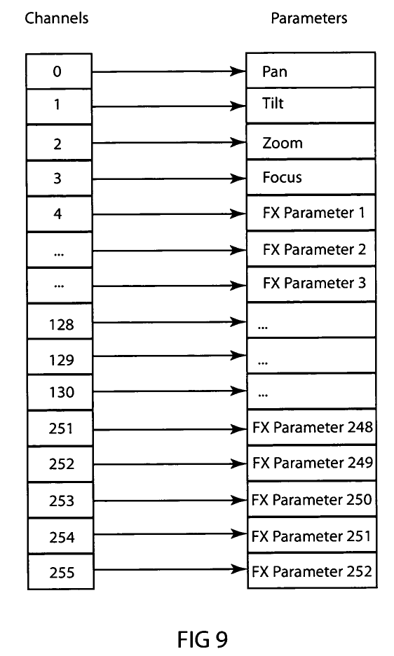

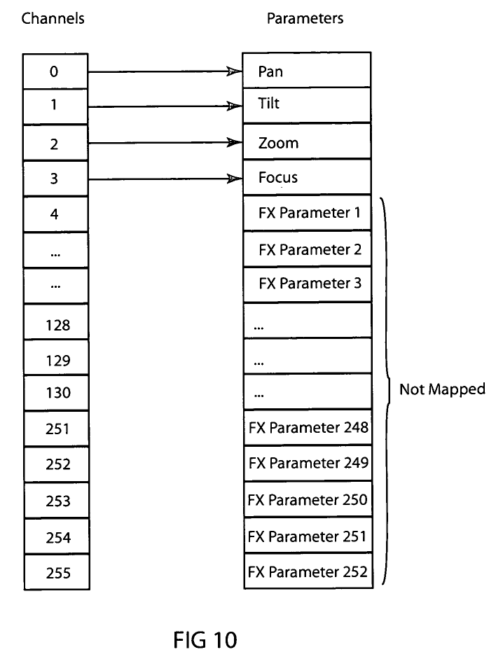

Such removal of channels may be extended as illustrated in FIGS. 9 and 10. FIG. 9 shows a one-to-one mapping of DMX512 channels to the parameters of an automated luminaire. The automated luminaire in this embodiment contains a large number of internal parameters (designated FX Parameter in the figure) such as would be found in a digital automated light where an internal media server provides multiple ways of manipulating an image. In such products many hundreds of DMX512 channels can be utilized for control of the internal media server. However, it is sometimes possible to utilize a separate, external media server with such a device. In such cases there is no longer a need to assign that large number of DMX512 channels to the automated luminaire. The present invention allows the remote removal of those DMX512 channels from the mapping and thus allows their re-use elsewhere. FIG. 10 illustrates the new mapping after the FX Parameter channels have been removed from the mapping. The core channels remain mapped.

Although just three examples of remapping are shown here the invention is not so limited and clearly a mapping with a combination of the techniques shown in FIGS. 3, 4, 9 and 10 may be established where channels are remapped and parameters are removed from the mapping at the same time.

In a further embodiment a mapping may be established on a ‘one to many’ basis where a single DMX512 control channel is mapped to multiple parameters simultaneously. For example DMX512 channel 3 may be mapped to both Tilt and Zoom parameters at the same time.

In a yet further embodiment a mapping may be established on a ‘many to one’ basis where multiple DMX512 control channels are mapped to a single parameter. For example DMX512 channels 3 and 4 may both be mapped to the Color parameter.

FIG. 5 illustrates a yet further embodiment of the invention and illustrates that the mapping from DMX512 channels may be directed to the parameters on different automated luminaire fixtures in an interleaved manner in order to collocate DMX512 channels controlling similar parameters on different automated luminaires. As illustrated channels 1 and 2 are mapped to the Pan parameters on Fixture 1 and 2 respectively and channels 3 and 4 are mapped to the respective Tilt channels. Such mapping may be advantageous in the control of such luminaires and facilitate their use and control.

In a still yet further embodiment of the invention the mapping may be extended to the values within the DMX channel. In a prior art system such mapping is again fixed, or selectable from a small number of offered pre-defined alternates. Each DMX512 channel represents an 8-bit number which has 256 possible values 0-255. Each of these values may be mapped to a particular command within a parameter. For example, on the color parameter, a channel value of 1 may indicate to the color mechanism that it is to move to color #1, a value of 2 may indicate that it is to move to color #2, a value of 255 may indicate to the color mechanism that it is to spin through all the colors and so on.

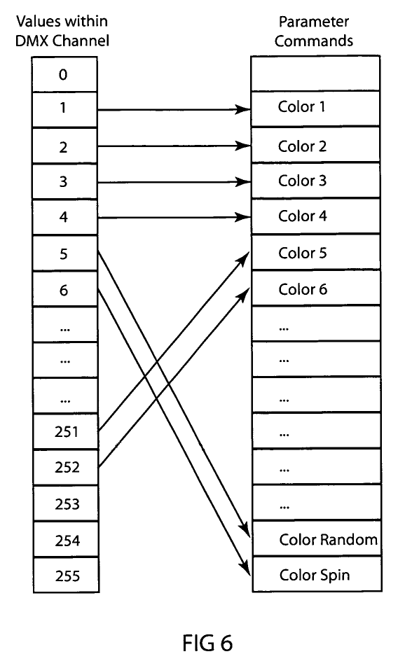

An embodiment of the invention herein described may allow the user to re-map the channel values to different parameters as desired or even to omit parameters altogether. FIG. 6 illustrates one such new mapping where channel values 1-3 have been mapped to the parameter commands for Colors 1-3 as before but channel value 5 has now been mapped to the ‘Color Random’ parameter command and channel value 6 has been mapped to the ‘Color Spin’ parameter command. Channel value 251 has been mapped to the parameter command for Color 5 and channel value 252 has been mapped to the parameter command for Color 6.

As with the channel mapping described earlier such channel value mapping may be configured to skip values, skip parameter commands or be applied on a ‘many-to-one’ or ‘one-to-many’ basis.

The mapping of channel values to parameter commands may be effected through a web page embedded in the automated luminaire, through a control panel or other user control on the automated luminaire, or through a DMX512 link using the RDM (Remote Device Management) protocol in a similar manner to that described for channel mapping above.

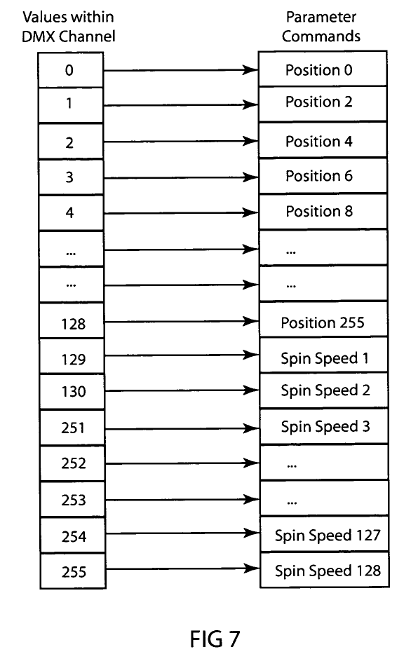

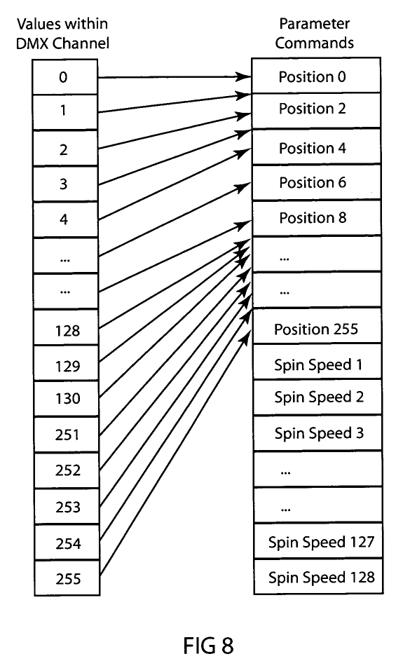

FIGS. 7 and 8 illustrate a further application of channel value mapping to increase the effective resolution of a parameter. FIG. 7 shows the prior art existing mapping of channel values to parameter commands where the parameter is a function capable of continuous positioning. An example of such a parameter could be the position of a color wheel. As illustrated in FIG. 7 channel values 0-128 are mapped to parameter commands relating to Position 0 through Position 255 for the color wheel. If, for example, the color wheel is capable of 360° of rotation then each increment of channel value will correspond to approximately 2.8° of rotation of the color wheel (360°/128). The remaining 128 channel values (128-255) are mapped to parameter commands relating to various speeds for spinning the color wheel.

In operation a user may prefer to have a higher resolution of positioning the color wheel and is prepared to forego the Spin Speed parameters to obtain this. FIG. 8 illustrates a possible mapping achievable though an embodiment of the invention to produce this.

In FIG. 8 all 256 channel values (0-255) are mapped to the parameter commands related to Position 0 through Position 255. Such mapping effectively doubles the resolution of the color wheel as each increment of channel value will now correspond to approximately 1.48° of rotation of the color wheel (360°/256).

Although only a few sample mappings have been illustrated herein the invention is not so limited and any combination of the mapping techniques described herein may be used simultaneously. Additionally multiple maps of this type may be established and stored within the automated luminaire for later use. In a yet further embodiment the channel or value mapping itself may be used to recall such stored mappings allowing the user to instantaneously switch between mappings as desired.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

What is claimed is:

1. A multiparameter automated luminaire control system comprising:
Luminaires that have channel assignments that can be remapped.
